(19) United States
(12) Patent Application Publication
(10) Pub. No.: US 2017/0300614 A1
(43) Pub. Date: Oct. 19, 2017

(54) HEAT DIFFUSION BASED GENETIC NETWORK ANALYSIS

(71) Applicants: Mark D.M. LEISERSON, Allston, MA (US); Fabio VANDIN, Sarego (VI) (IT); Hsin-Ta WU, Providence, RI (US); BROWN UNIVERSITY, Providence, RI (US)

(72) Inventors: Benjamin J. RAPHAEL, Providence, RI (US); Mark M.D. LEISERSON, Allston, MA (US); Fabio VANDIN, Sarego (VI) (IT); Hsin-Ta WU, Providence, RI (US)

(21) Appl. No.: 15/515,571

(22) PCT Filed: Sep. 30, 2015
(86) PCT No.: PCT/US2015/053330

§ 371 Date: Mar. 29, 2017

Related U.S. Application Data
(60) Provisional application No. 62/057,479, filed on Sep. 30, 2014.

(51) Int. Cl. G06F 19/12; G06F 19/22

(52) U.S. Cl. CPC G06F 19/12; G06F 19/22

(57) ABSTRACT

Methods and devices are provided for performing heat diffusion based genetic analysis. A network comprising a plurality of genes is defined an initial heat score is assigned to each of the plurality of genes. A threshold value for evaluating whether heat will be diffused from each of the plurality of genes within the network is assigned. Heat from at least one of the plurality of genes is diffused across the network, and after reaching equilibrium, the network is partitioned into a hierarchy of subnetworks according to an amount and a direction of heat exchange amongst each of the plurality of genes, and a statistical significance of the partitioned network and/or hierarchy of partitioned networks is assessed.

### CROSS-REFERENCE TO RELATED APPLICATIONS

This application is being filed on 30 Sep. 2015, as a PCT International application and claims the benefit of priority of U.S. Provisional Application No. 62/057,479, filed Sep. 30, 2014, entitled “PAN-CANCER NETWORK ANALYSIS,” the entirety of which is hereby incorporated by reference.

### GOVERNMENT LICENSE RIGHTS

This invention was made with government support under IIS 61/016,648 awarded by the National Science Foundation (NSF) and R01HG005690 and R01HG007069 awarded by the National Institutes of Health (NIH). The government has certain rights in the invention.

### INCORPORATION BY REFERENCE

Details regarding the heat diffusion based genetic network analysis system and methods, in addition to those discussed herein, are also provided in the paper Pan-Cancer Network Analysis Identifies Combinations of Rare Somatic Mutations Across Pathways and Protein Complexes, Leiserson et al., Nat. Genet., February 2015.

### BACKGROUND

Recent whole-genome and whole exome sequencing studies have provided an ever-expanding survey of somatic aberrations in cancer, and have identified multiple new cancer genes. These studies have also demonstrated that most cancer types exhibit extensive mutational heterogeneity: relatively few genes are recurrently mutated in many samples, while many genes are mutated in a small number of samples. This “long tail” phenomenon complicates efforts to identify cancer genes based on their recurrence across samples. That is, rarely mutated cancer genes may be indistinguishable from genes containing only passenger mutations by statistical tests of recurrence. Thus, studies with a relatively large number (˜500) of cancer samples such as The Cancer Genome Atlas (TCGA) Research Network report relatively small lists (˜10-35) of significantly mutated genes (SMGs). The TCGA Research Network utilizes a Pan-Cancer Analysis, which aims to examine the similarities and differences among the genomic and cellular alterations found across diverse tumor types. Such lists are not thought to contain all important cancer genes in these samples, leaving an incomplete summary of the functional, somatic mutations. Even recent TCGA Pan-Cancer studies have limited power to characterize genes in the long tail.

A prominent explanation for the observed mutational heterogeneity and long tail of rarely mutated genes is that genes act together in various signaling/regulatory pathways and protein complexes. Thus, different combinations of mutations may perturb these interacting proteins in different individuals. Cancer sequencing papers often contain figures showing the appearance of mutations on known pathways, but these figures are manually constructed and do not demonstrate that the observed clustering of mutations on displayed genes is statistically significant. Standard computational approaches to analyze mutations on pathways and protein complexes are severely limited by the statistical requirement of defining a reasonable number of gene sets, or combinations of genes to evaluate. This imposes multiple undesirable constrains.

First, gene sets often contain dozens of genes, reducing the power to identify a smaller subset containing a few directly interacting proteins. Second, there is typically extensive overlap between annotated gene sets, complicating the interpretation of analyses that report tens to hundreds of “significant,” but overlapping, pathways. Third, by ignoring the topology of interactions, gene-set analyses have reduced ability to identify crosstalk between pathways. Finally, a definition of gene sets prevents the discovery of novel combinations of mutations.

The papers discussed below are provided as a general reference with regard to previously disclosed techniques that are frequently utilized in performing Pan-Cancer analyses as will be well known to those of skill in the art.

Emerging Landscape of Oncogenic Signatures Across Human Cancer, Ciriello et al., Nat. Genet. (2013) focuses on the clustering of samples in the Pan-Cancer dataset according to the presence or absence of recurrent mutations. However, it does not attempt to identify novel somatic aberrations by analyzing combinations of events, thus its analysis misses a number of known and novel cancer genes in the TCGA data.

Discovery and Saturation Analysis of Cancer Genes Across 21 Tumour Types, Lawrence et al., Nature (2014) predicts cancer genes from somatic single nucleotide variants (SNVs) in large sample cohorts from 21 cancer types, containing more than 2000 tumors outside of the TCGA Pan-Cancer cohort, and identifies both known and novel cancer genes. Like others before it, Lawrence studies single types of mutations, either SNVs or copy number alterations (CNAs), in single genes, rather than jointly analyzing both types.

It is with respect to this general technical environment that aspects of the present technology disclosed herein have been contemplated.

### SUMMARY

This summary is provided to introduce a selection of concepts in a simplified form that are further described in the Detailed Description section. This summary is not intended to identify key features or essential features of the claimed subject matter, nor is it intended to be used as an aid in determining the scope of the claimed subject matter.

Non-limiting examples of the present disclosure describe computer-implemented methods and systems for performing heat diffusion based genetic network analyses. In aspects of the heat diffusion based genetic network analyses a network comprising a plurality of genes is compiled. Upon compiling the network an initial heat score, as defined by one or both of gene mutation frequency and/or gene mutation significance, is assigned to each of the genes within the compiled network. A threshold value for evaluating whether heat will be diffused from each of the genes within the network is assigned and heat from at least one of the genes is diffused across the network. After reaching equilibrium, the genes within the network are partitioned into subnetworks according to an amount and a direction of heat exchange amongst each of the genes within the network, and statistical significance of the partitioned network is assessed.

### BRIEF DESCRIPTION OF THE DRAWINGS

Non-limiting and non-exhaustive examples are described with reference to the following figures. As a note, the same number represents the same element or same type of element in all drawings.

FIG. 1 illustrates one example of a suitable operating environment for implementing aspects of the disclosure.

FIG. 2 is an example of a computing network in which the various systems and methods for heat diffusion based network analysis may operate.

FIG. 3 is a flowchart depicting methods of operation according to examples disclosed herein.

FIG. 4 illustrates heat assignment to genes/nodes according to an aspect of the disclosure.

FIG. 5 illustrates heat diffusion amongst a gene/node network according to an aspect of the disclosure.

FIG. 6 illustrates partitioning of subnetworks after equilibrium in an exemplary network is reached.

FIG. 7 illustrates one example of heat distribution amongst neighboring genes/nodes.

### DETAILED DESCRIPTION

Various aspects are described more fully below with reference to the accompanying drawings, which form a part hereof, and which illustrate aspects of the present disclosure. These examples may be implemented in many different forms and aspects of the present disclosure should not be construed as being limited to the examples set forth herein.

Non-limiting and non-exclusive examples of the present disclosure describe methods and systems for performing heat diffusion based genetic network analyses. A network comprising a plurality of genes is defined and an initial heat score is assigned to each of the plurality of genes. A threshold value for evaluating whether heat will be diffused from each of the plurality of related genes within the network is assigned. Heat from at least one of the plurality of genes is diffused across the network. After reaching equilibrium, the network is partitioned into subnetworks according to an amount and a direction of heat exchange amongst each of the plurality of genes, and statistical significance of the partitioned network is assessed.

Aspects of the present disclosure provide methods and systems for providing an objective, less biased analysis of gene combinations and enable the discovery of novel combinations of interacting proteins. The present disclosure also describes techniques to jointly analyze SNVs and CNAs—a vital feature when analyzing multiple cancer types with different landscapes.

In examples, the heat score applied to each of the plurality of genes within the network, and the process by which heat is diffused across the network is conceptually related to heat transfer equations and analytics used in thermodynamics for applications such as determining heat distribution within electrical circuits. In contrast, according to aspects of the disclosure, a heat diffusion based genetic network analysis dissipates heat across a network comprised of genes, rather than components of an electrical circuit, and each gene is given an initial heat score corresponding to its mutation significance as computed by using an algorithm such as MutSigCV (which analyzes lists of mutations discovered in DNA sequencing to identify genes that were mutated more often than expected by chance given background mutation processes) and/or its mutation frequency. As in thermodynamics, heat is allowed to dissipate across the network, but in the network analysis performed according to examples disclosed herein, heat moves from “hot” nodes to “cold” nodes, according to their assigned heat scores. The term “node”, as referred to herein and as used throughout refers to the representation of an individual gene, such as the representations of genes as depicted in the Figures herein.

The present disclosure further describes assigning an initial heat score to each of the plurality of related genes, which comprises analyzing the frequency with which each of the plurality of related genes is mutated, and assigning mutation significance to each of the plurality of related genes using MutSigCv q-values.

According to aspects of the disclosure, assigning an initial heat score to each of the plurality of related genes is based on the probability model (e.g. MutSigCV) for assigning a heat score correlating to mutation significance individually for each of the plurality of related genes. The input data to MutSigCV utilizes input data consisting of lists of mutations (and indels) from a set of samples (patients) that were subjected to DNA sequencing, as well as information about how much genetic territory was covered in the sequencing.

MutSigCV was originally developed for analyzing somatic mutations, but it has also been utilized in analyzing germline mutations. MutSigCV has been used for various applications such as, for example, constructing models of the background mutation processes that are at work during formation of tumors, as well as analyzing the mutations of each gene to identify genes that are mutated more often than expected by chance, given the background model. A critical component of MutSigCV is the background model for mutations, the probability that a base is mutated by chance. Patients being analyzed do not all have the same background mutation rate, or the same spectrum of mutations. Similarly, not all regions of the genome (or exome) have the same basic mutation patterns. The “CV” in MutSigCV stands for “covariates.” MutSigCV starts from the observation that the data is very sparse, and that there are usually too few silent mutations in a gene for its background mutation rate (BMR) to be estimated by any confidence. MutSigCV improves the BMR estimation by pooling data from “neighbor” genes in covariate space. These neighbor genes are chosen on the basis of having similar genomic properties to the central gene in question: properties such as DNA replication time, chromatin state (open/closed), and general level of transcription activity (e.g. highly transcribed vs. not transcribed at all). These genomic parameters have been observed to strongly correlate (co-vary) with BMR. For instance, genes that replicate early in S-phase tend to have much lower mutation rates than late-replicating genes. Genes that are highly transcripted also tend to have lower mutation rates than unexpressed genes, due in part to the effects of transcription-coupled repair (TCR). Genes in closed chromatin (as measured by HiC or ChipSeq) have higher mutation rates than genes in open chromatin. Incorporating these covariates into the background model substantially reduces the number of false positive findings associated with earlier models utilizing similar methods.

According to other aspects, an initial heat score is only assigned to genes that are statistically significant using a p-value <0.05 or a q-value <0.2 according to a single gene test of statistical significance. The MutSigVG q-score as used herein corresponds to a value relating to the false discovery rate (FDR), which conceptualizes the rate of type I errors in null hypothesis testing when conducting multiple comparisons utilizing FDR-controlling procedures designed to control the expected proportion of rejected null hypotheses that were incorrect rejections.

According to examples, assigning an initial heat score to each of the plurality of related genes further comprises analyzing the mutation frequency of each of the plurality of related genes and assigning a correlating heat score to each of the plurality of related genes based on its mutation frequency.

Analyzing the mutation frequency of each of the plurality of related genes further comprises determining a proportion of samples with at least one SNV, determining a proportion of samples within at least one CNA, determining a proportion of samples containing at least one indel, or determining a proportion of samples containing at least one splice-site mutation.

In yet another example, assigning a threshold value to the network further comprises filtering a subset of the plurality of related genes from the network, removing ultra and hypermutators, and/or removing genes from the network which contain less than a pre-defined number (or percentage of samples) containing SNVs. In certain aspects, the pre-defined percentage of SNVs is a percentage in the range of 0.01-10%.

The disclosed algorithm utilized in the heat diffusion based genetic network analysis provides for assessing the statistical significance of the partitioned data. This assessment is done to determine whether the results of the heat diffusion correlate to actual biological relationships within the genetic pathways, or if the diffusion is due purely to chance. Assessing the statistical significance comprises computing a gene score wherein the gene score is defined by p-value and FDR for each of: SNVs, small indels, splice-site mutations from exome sequencing data, CNAs from SNP array data, and gene expression from RNA-seq data.

The method may also include arranging the subnetworks near a plurality of cancer types where the subnetworks are enriched for mutations. Force-directed layout may be utilized to arrange the subnetworks near the plurality of cancer types.

The present disclosure identifies several methods for assigning heat scores to each of the plurality of related genes. In one example, the method may include assigning a plurality of heat scores to each of the plurality of related genes, wherein the plurality of heat scores are combined prior to diffusing heat from at least one of the plurality of genes across the network.

In contrast to traditional thermodynamics in which a calculated “heat score” corresponds to an actual temperature of an object, a heat score according to aspects of the current disclosure may comprise a combined value for mutation significance and mutation frequency within nodes. Therefore, the higher the heat score for a particular node, the higher the likelihood that its heat will diffuse to other nodes within the composed network and affect a genetic pathway. According to another aspect, the method may include assigning a plurality of heat scores to each of the plurality of related genes, wherein the plurality of heat scores are applied to each of the plurality of related genes individually and each individual heat score for each individual gene is diffused across the network.

In other examples, assessing statistical significance of the portioned network comprises combining data from the plurality of heat scores after diffusing heat from at least one of the plurality of genes across the network. This assessment is done to determine whether the results of the heat diffusion correlate to actual biological relationships within the genetic pathways, or if they might be purely due to chance.

A number of technical advantages are achieved based on the present disclosure including, but not limited to: utilizing a directed heat diffusion model to simultaneously assess both the significance of mutations in individual proteins and the local topology of a proteins interactions, reporting a small number of subnetworks of interacting genes, with no redundancy, allowing for more focused predictions of complexes that are significantly mutated, and providing both new insights and a simpler summary of groups of interacting genes.

Aspects of the present disclosure extend previous methods for analyzing relationships among cancer mutations in additional ways. First, the algorithm utilized in the heat diffusion based genetic network analysis disclosed herein employs an insulated heat diffusion process that better encodes the local topology of the neighborhood surrounding a protein in the interaction network compared to the diffusion process employed by previous methods. Second, the present algorithm considers the non-symmetric influence F(i,j) between two proteins gᵢ, gⱼ to derive a directed measure of similarity E(i,j) between them. Third, the present algorithm identifies strongly connected components in the directed graph, instead of the connected components of an undirected graph as done by previously disclosed methods. This allows for effective detection of significant subnetworks in datasets in which the number of samples is order(s) of magnitude larger than considered by previous methods, and in which the mutational frequencies, or scores, occupy a broad range (from very common to extremely rare).

Expanding on this third point, when undirected diffusion algorithms or related network propagation algorithms are run on large datasets containing a wide range of gene scores (e.g., the Pan-Cancer dataset), many of the resulting subnetworks are “hot” (i.e. having a high degree of mutation significance as defined by MutSigCV and/or mutation frequency) star graphs determined by a single high-scoring node and the immediate neighbors of this node.

Star graphs, or more generally, spider graphs are graphs with one central node (root node) and neighboring nodes. While the hot, center node in these star graphs is typically a significant gene, the neighboring nodes are often artifacts. In comparing the proportion of subnetworks returned by previous methods and aspects of the disclosure on Pan-Cancer mutation data that are star/spider graphs dominated by a hot, central node, examples disclosed herein return greater than 80% fewer hot stars/spiders than previous methods. This significant difference is explained by the undirected vs. directed heat similarity measures used in examples disclosed herein as different from previously used methods.

Employing previous methods (using undirected heat), placing a high heat score on a node with relatively low-degree is likely to result in a hot star/spider configuration. Such configurations are found frequently in randomly permuted data, such that the number and size of subnetworks found in real data may not be significant. By contrast, according to examples disclosed herein (using directed heat), a single high heat score placed on a random node will not result in a hot star/spider configuration. Consequently, by analyzing the direction of heat flow, aspects as disclosed herein return fewer hot star/spider configurations on both real and random data, and thus the number and size of subnetworks found in real data is significant.

While aspects of the disclosure are useful in identifying novel cancer pathways, methods according to the disclosure are suitable for other applications, both biological and non-biological, and the Pan-Cancer experiments disclosed herein are provided only as a means for explaining certain exemplary aspects of the analysis.

In particular, genome-wide association (GWA) studies and other studies of genetic diseases also face the problem of identifying combinations of genetic variants with a statistically significant association to a phenotype. For example, GWA studies typically lack power to detect genotypes harboring statistically significant associations with complex diseases, where different causal mutations of small effect may be present in different cases. A common, tractable approach is to evaluate combinations of variants in known pathways or gene sets with shared biological function. Such gene-set analyses require the computation of gene scores from GWA SNP p-values. These gene scores are also useful when generating hypotheses for experimental validation. However, commonly used methods for generating gene scores from GWA results are computationally inefficient, biased by gene length, imprecise, and have low sensitivity at low false positive rates (FPR), leading to erroneous hypotheses for functional validation. However, according to examples of the disclosure, methods are provided for identifying novel genetic pathways for a variety of diseases by calculating gene scores from SNP-level p-values utilizing the precise, efficient gene association score using SNPs (PEGASUS). PEGASUS corrects for linkage disequilibrium and produces gene scores with as much as 10 orders of magnitude higher precision than competing methods, achieving up to 30% higher sensitivity when the FPR is fixed at 1%. Utilizing the gene scores from PEGASUS as input to the heat diffusion based genetic network analyses and their corresponding algorithms disclosed herein, networks of interacting genes associated with several complex diseases and traits, in addition to various cancer types, can be identified. Non-limiting examples of such complex diseases and traits for which these identifications can be made utilizing PEGASUS and the heat diffusion based genetic network analyses disclosed herein include: ulcerative colitis, waist-hip ratio, and attention deficit/hyperactivity disorder.

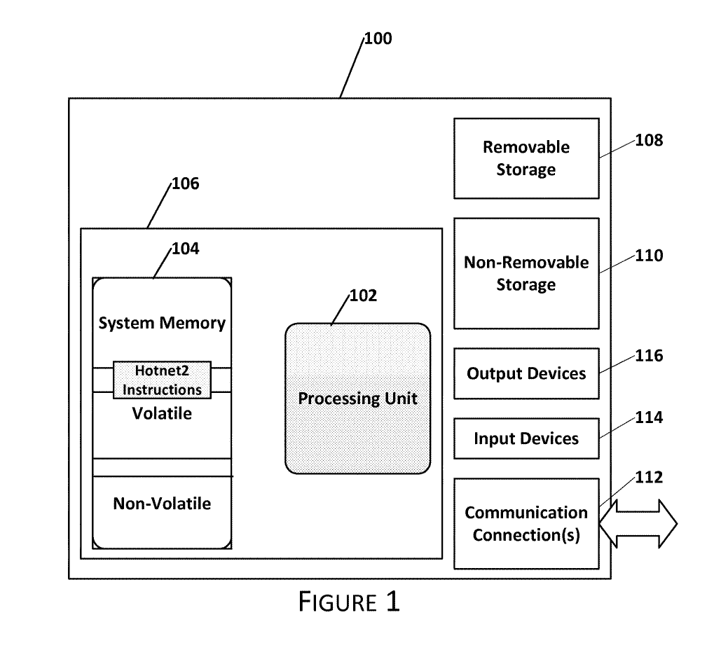

FIG. 1 and the additional discussion in the present specification are intended to provide a brief general description of a suitable computing environment in which the present invention and/or portions thereof may be implemented. Aspects of the present disclosure as described herein may be implemented as computer-executable instructions such as by program modules or applications, being executed by a computer, such as a client workstation or a server, including a server operating in a cloud environment. Generally, program modules or applications include routines, programs, objects, components, data structures, and the like that perform particular tasks or implement particular abstract data types. Moreover, it should be appreciated that aspects of the present disclosure or portions thereof may be practiced with other computer system configurations, including hand-held devices, multi-processor systems, microprocessor-based programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices. The figures depict the general structure geometries of the technologies described herein.

FIG. 1 illustrates one example of a suitable operating environment 100 in which one or more of the present examples according to the disclosure may be implemented.

In its most basic configuration, operating environment 100 typically includes at least one processing unit 102 and memory 104. Depending on the desired configuration and type of computing device used to implement the memory 104 (storing, among other things, sequential chains constructed as described herein) may be volatile (such as RAM), non-volatile (such as ROM, flash memory, etc.), or some combination of the two. Memory 104 may store computer instructions related to performing heat diffusion genetic network analysis methods disclosed herein. Memory 104 may also store computer-executable instructions that may be executed by the processing unit 102 to perform the methods disclosed herein.

The operating environment 100 may also include storage devices (removable 108, and/or non-removable 110) including, but not limited to, magnetic or optical disks or tape. Similarly, environment 100 may also have input device(s) 114 such as keyboard, mouse, pen, voice input, etc. and/or output device(s) 116 such as a display, speakers, printer, etc. Also included in the environment may be one or more communication connections, 112, such as LAN, WAN, point to point, etc.

Operating environment 100 typically includes at least some form of computer readable media. Computer readable media can be any available media that can be accessed by processing unit 102 or other devices comprising the operating environment. By way of example, and not limitation, computer readable media may comprise computer storage media and communication media. Computer storage media includes volatile and non-volatile, removable and non-removable media implemented in any method or technology for storage of information such as computer readable instructions, data structures, program modules, or other data. Computer storage media includes, RAM, ROM, EEPROM, flash memory or other memory technology, CD-ROM, digital versatile disks (DVD) or other optical storage magnetic cassettes, magnetic tape, magnetic disk storage or other magnetic storage devices, or any other medium which can be used to store the desired information. Communication media embodies computer readable instructions, data structures, program modules, or other data in a modulated data signal such as a carrier way or other transport mechanism and includes information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 100 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets, and the Internet.

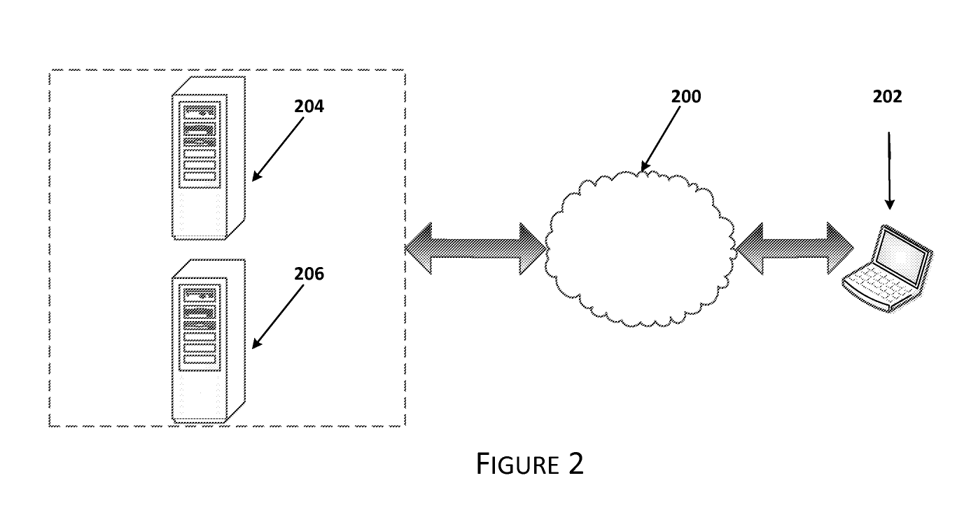

FIG. 2 is an example of a network 200 in which the various systems and methods disclosed herein may operate. In examples, client device 202, may communicate with one or more servers, such as servers 204, via a network 208. According to aspects of the disclosure, a client device may be a laptop, a personal computer, a smart phone, a tablet computing device, or any other type of computing device. Network 208 may be any type of network capable of facilitating communications between the client device and one or more servers 204 and 206. Examples of such networks include, but are not limited to, LANs, WANs, cellular networks, and/or the Internet.

In aspects according to the disclosure, the various systems and methods disclosed herein may be performed by one or more server devices. For example, in one example, server 204 may be employed to perform the heat diffusion based genetic network analysis methods disclosed herein. Client device 202 may interact with server 204 via network 208 in order to access information such as, genetic information, heat diffusion based genetic network analysis algorithmic data, and/or functionality disclosed herein. In further aspects, the client device 202 may also perform functionality disclosed herein.

In alternative examples, the methods and systems disclosed herein may be performed using a distributed computing network, or a cloud network. In such examples, the methods and systems disclosed herein may be performed by two or more servers 204 and 206. Although particular network examples are disclosed herein, one of skill in the art will appreciate that these systems and methods may be performed using other types of configurations.

The following provides a non-limiting description of the heat diffusion based genetic network analyses described herein.

The current disclosure presents methods and systems for performing heat diffusion based genetic network analyses. These methods and systems expand upon previous methods for analyzing relationships amongst cancer mutations. They do so by performing an analysis that identifies subnetworks of a larger scale genome interaction network that are mutated more than expected.

Interaction networks have been proven useful in analyzing various types of genomic data. However, statistically robust identification of significantly mutated subnetworks is a difficult, high-dimensional analysis problem with three major challenges. First, the number of subnetworks is too large to test exhaustively in a computationally efficient and statistically rigorous manner, e.g., >10¹⁴ subnetworks of ≧5 proteins in a medium-size human interaction network. Second, the topology of biological interaction networks is heterogeneous; many proteins, and in particular many cancer-related proteins, have a large number of neighbors. Third, both the frequency of somatic mutations in individual genes/proteins and the topology of the interactions between proteins determine the significance of a subnetwork. While approaches have been introduced to find network modules, rank gene sets, or prioritize disease-related genes, these approaches consider only network topology and not the scores of individual genes.

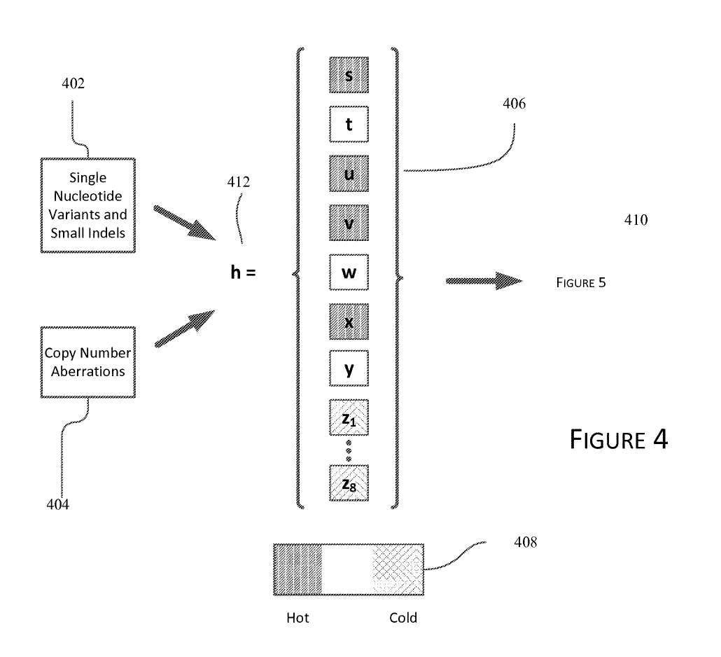

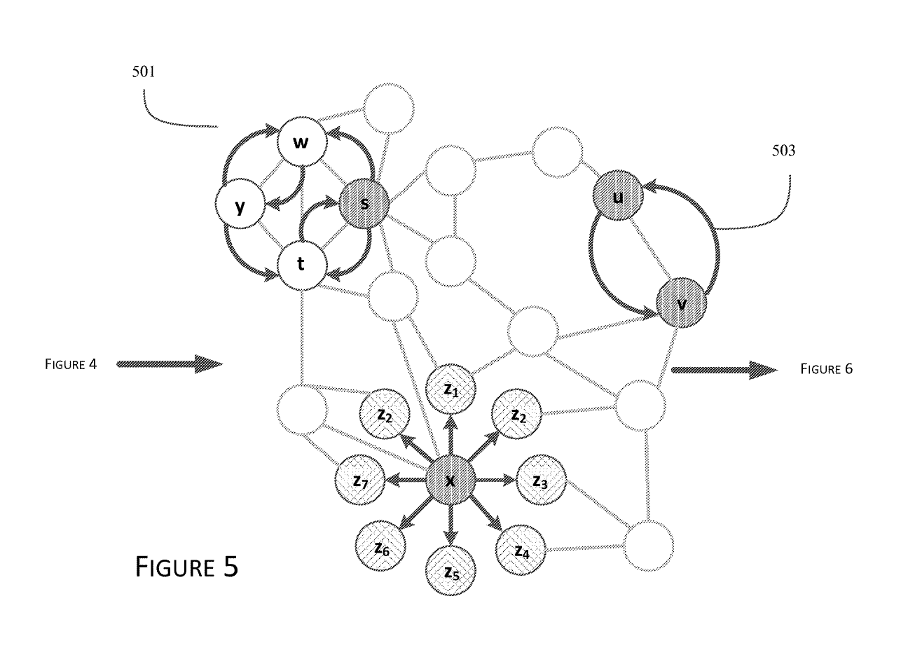

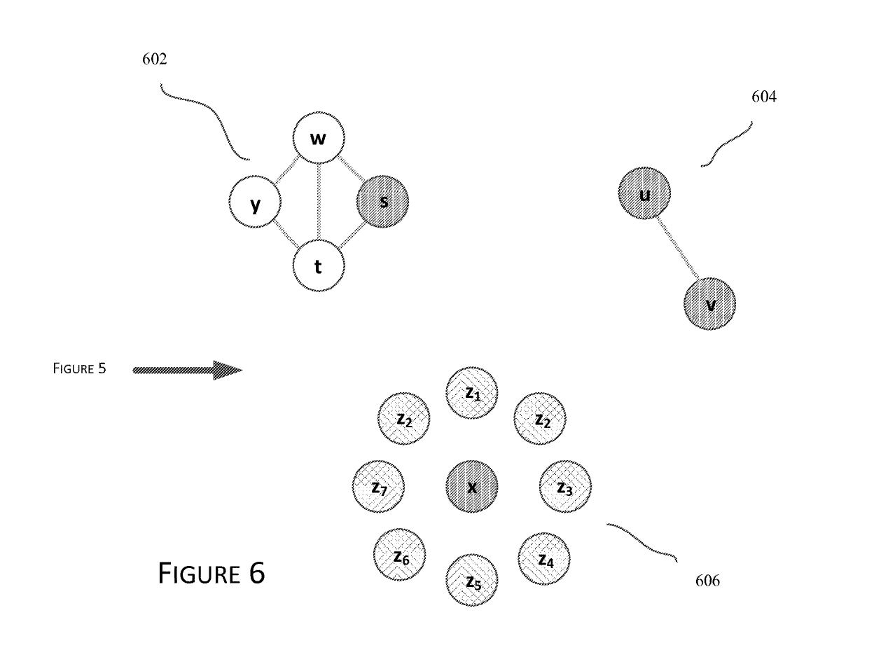

The heat diffusion based genetic network analyses according to aspects of the disclosure identify significantly mutated subnetworks of a genome-scale interaction network, using an insulated heat diffusion process that considers both the scores on individual genes or proteins as well as the topology of interactions between those genes or proteins as illustrated by FIG. 4, FIG. 5 and FIG. 6.

In examples, simultaneous analysis of gene scores and local network topology is utilized because the local topology of biological interaction networks is heterogeneous, e.g., there are genes (including many cancer genes) with a large number of interactions. If such genes also have high heat scores assigned to them, then a large fraction of the genes in the network will be positioned near a high-scoring gene in the network. Thus, observing two genes with moderate scores, but sharing many common interactions in a network provides a more useful means for identifying novel cancer pathways than recognizing two genes with high scores that are connected through a gene with many neighbors.

Aspects of the disclosure employ a heat score input 412 (i.e., mutation significance and mutation frequency) that is applied to each of the genes 406 which compose the network 501 upon which heat is eventually distributed. The input to the network analysis is: a heat vector \vec{h} 412, which contains the scores for each gene. Heat is diffused across the network 501, which results in an overlap between nodes and edges corresponding to interactions amongst genetic pathways.

### Heat Diffusion

Examples of the heat diffusion based genetic network analysis disclosed herein employ an insulated heat diffusion process that captures the local topology of the interaction networks surrounding a node. As the heat diffusion algorithm is run on the network, heat is diffused amongst the nodes within the composed network 501, whereby nodes in the graph pass to and receive heat 503 from neighboring nodes, but also retain a fraction β of their heat, governed by an insulating parameter β. According to aspects of the disclosure insulating parameter β is chosen for a given node-node interaction network, and remains fixed for different heat datasets. Insulating parameter β balances the amount of heat that diffuses from a protein to its immediate neighbors and to the rest of the network 501. This may be accomplished by computing the amount of heat retained in the neighbors of vertices (“source proteins”) with different network centrality.

The process is performed until the network 501 reaches an equilibrium point. At equilibrium there will be a distribution of heat on the nodes of the graph; due to the insulation at each node (i.e. insulating parameter β), the heat will generally not be equal at each node. Rather, the amount of heat on each node at equilibrium depends on its initial heat from the input vector \vec{h} 406, the local topology of the network 501 around the node, and the value of insulating parameter β.

The value of the parameter β is chosen using a procedure that preserves a user-desired amount of information in the network. Parameter β is chosen for a given protein-protein interaction network, and remains fixed for different heat datasets. This parameter balances the amount of heat that diffuses from a protein to its immediate neighbors and to the rest of the network. According to examples this may be accomplished by computing the amount of heat retained in the neighbors of vertices (“source proteins”) with different network centrality. Specifically, computation of betweenness centrality for each protein v, that is, the number of shortest paths between all pairs of proteins that pass through v. Upon computing the betweenness centrality a number of source proteins from the network may be chosen, for example those with the minimum, 25% quantile, median, 75% quantile, and maximum betweenness centrality. An examination of vertices with different network centrality may be performed in order to choose diffusion parameter β such that all proteins within the network retain most of their heat in their immediate neighbors.

If a unit heat source is placed at node j (e.g., a mutation in gⱼ in one sample) then the amount of heat on node I is given by the (i,j) entry of the diffusion matrix F defined by:

F=β(I−(1−β)W)⁻¹,

where

$${W}_{ij} = \{ \begin{matrix}\frac{1}{deg ( i )} , & if node i interacts with node j \\ 0 , & otherwise\end{matrix}$$

Thus, W is a normalized adjacency matrix of the network. F(i,j) is interpreted as the influence that a heat source placed on gⱼ has on protein jᵢ. The insulated heat model can also be described in terms of a random walk with restart. According to an example, the insulated diffusion process is generally asymmetric, i.e. F(i,j)≠F(j,i). The diffusion matrix F depends only on the network, and not the heat vector \vec{h}. Therefore the influence (for a given β) needs to be computed only once for a given interaction network.

### Asymmetry of Heat Diffusion

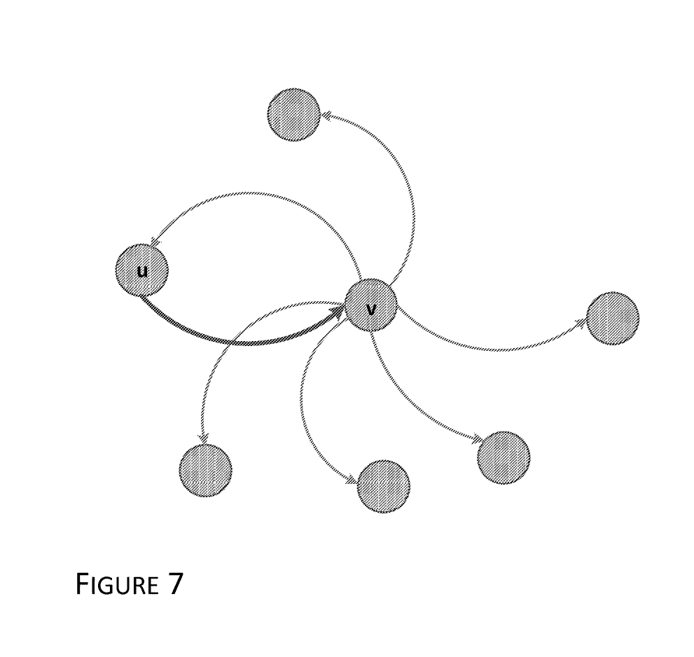

Clustering algorithms, graphical or otherwise, necessarily depends on a notion of distance, or oppositely similarity, between points. Distances are by definition symmetric; however, similarity might not be symmetric. For example, some models of protein sequence similarity are non-symmetric. According to aspects of the heat diffusion based genetic network analysis disclosed herein, similarity is non-symmetric for two reasons: first, the local topology of a pair of nodes u and v in the network 501 which is encoded in the heat diffusion process—is not symmetric. A simple example is shown in FIG. 7. There, node u sends all of its heat to its neighbor v, but v sends heat to many nodes, including u. Thus, by way of example, u might be “closer” to v that v is to u. Second, the heat score assigned to nodes u and v would typically be different.

### Exchanged Heat Matrix

The insulated heat diffusion process described above encodes the local topology of the network 501, assuming unit heat is placed on nodes. To jointly analyze network topology and gene scores given by the initial heat vector \vec{h} the exchanged heat matrix E is defined:

$$E = F {D}_{\vec{{h}^{′}}}$$

where

$${D}_{\vec{{h}^{′}}}$$

is the diagonal matrix with entries \vec{h}. E(i,j)=F(i,j) \vec{h}(j) is the amount of heat that diffuses from node gⱼ to node gⱼ on the network when \vec{h}(j) heat is placed on gⱼ, which is interpreted as the similarity of gⱼ, gᵢ. Since the diffusion matrix F is not symmetric and in general \vec{h}(i)≠\vec{h}(j), the similarity E(i,j) is not symmetric. This non-symmetry of the similarity measure results from advantages related to modeling the differences in the network topology around pairs of nodes.

### Identification of Hot Subnetworks

According to aspects of the disclosure a weighted directed graph whose nodes are all measured genes is formed. If E(i,j)>δ, then there is a directed edge from node j to node j of weight E (i,j). The edge weight parameter δ is determined such that no large subnetworks are found in random data by permuting initial heat vector \vec{h}.

According to another implementation, the value of the edge weight parameter δ is not selected in advance. Rather, a hierarchy of subnetworks is determined by computing a hierarchical decomposition of the exchanged heat matrix E using an algorithm to define a hierarchy of strongly connected components as more fully described in the publication An Improved Algorithm for Hierarchical Clustering Using Strong Components, R. E. Tarjan, Information Processing Letters, Volume 17, Issue 1, July 1983.

### Statistical Test for Subnetworks

Examples of the heat diffusion network analysis disclosed herein employ a statistical test to determine the significance of the number and size of the subnetworks determined in the identification of hot subnetworks step described above.

In examples, the heat diffusion network analysis has two parameters β and δ, and selects values for both of these parameters using automated procedures. β is selected from the protein-protein interaction network, independently of any gene scores. According to examples, the value δ is chosen such that large connected components are not found using the observed gene score distribution on random networks with the same degree distribution as the observed network.

The disclosed heat diffusion network analysis addresses issues related to a broad spectrum of mutational frequencies—from common to extremely rare mutations—in TCGA Pan-Cancer datasets. Namely, highly mutated genes such as, for example, TP53, will yield “star subnetworks” centered on these extremely “hot” nodes, even though many of the neighbors of these stars may not be mutated at an appreciable frequency and are of limited biological interest. Aspects of the heat diffusion network analysis address this issue by using a modified heat diffusion process and consider the source and directionality of heat flow when identifying subnetworks. This approach may reduce the artifact of star/spider subnetworks by more than 80%, thereby reducing the false positive rate and enabling the identification of more subtle subnetworks with rare mutations of high biological relevance.

It will be understood by those of skill in the art that many factors determine the significance of mutations in individual genes, including the frequency of recurrence across samples, gene length, mutation context, regional variation in mutation rates, etc. Several approaches have been introduced to account for these factors. The disclosed heat diffusion network analysis uses a multi-factor approach in assigning heat to individual genes (represented by nodes) according to recurrence and predicted functional impact. That is, the network analysis assigns heat to genes using a combination of: (1) mutation frequency, which is the proportion of samples with a SNV, small indel, or CNA; and (2) p-values or q-values measuring the mutation significance of individual genes or nodes, such as values computed by MutSigCV or related approaches. These two scoring schemes provide opposite extremes in terms of stringency. The mutation frequency scores provide an opportunity for higher sensitivity, particularly for rarely mutated genes or genes primarily mutated by CNAs. Alternatively, MutSigCV assesses the statistical significance of individual genes, and identifies genes falling within a specific q value within a dataset, which provides high specificity.

### Experimental Results

In experiments, mutation frequency was determined for 10,208 genes, and MutSigCV q-values were measured for 10,215 genes. Three interaction networks with varying numbers of interactions were utilized to allow for different false positive and false negative interactions in the analysis: (1) HINT+HI2012, a combination of high-quality protein-protein interactions from HINT and the HI-2012 set of protein-protein interactions; (2) MultiNet, a network that integrates multiple types of interactions from different databases; and (3) iRefIndex, an integrated network from multiple data sources. These three interaction networks have different trade-offs in sensitivity vs. specificity that would not be represented by simply merging the three networks.

Aspects of the heat diffusion network analysis disclosed herein allow for identification of gene subnetworks that may play a role in cancer development or other genetic disease by way of complex genetic pathways that were previously undiscovered. Heat diffusion based genetic network analysis identified a significant number of subnetworks (P<0.0001) for each of the two gene scores and three networks. The resulting subnetworks from the experiments described above were combined into 14 consensus subnetworks that were found across different gene scores and networks in addition to the condensing complex and CLASP/CLIP proteins that were significant in individual subnetworks with the mutation frequency score. The consensus process also identified 13 “linker” genes that are members of more than one consensus subnetwork. The subnetworks and linker genes include: portions of cancer pathways well known to those of skill in the art, such as TP53, PI3K, NOTCH, and receptor tyrosine kinases (RTKs); as well as pathways and complexes that have more recently been observed to be important in cancer such as SWI/SNF complex, NFE2L2-KEAP1, RUNX1-CBFB core binding complex, and BAP1 complex. The fifth most mutated subnetwork (16.9% of samples) consists of MLL2 and MLL3 and the putative interacting protein KDM6A, and was also found to be highly mutated (28.9%) in TCGA Pan-Cancer squamous integrated subtype. The network analysis identified less-characterized and potentially novel subnetworks that may have important roles in cancer, including the cohesion and condensing complexes and MHC Class I proteins. The MHC Class I subnetwork is an example of the ability of the network analysis to identify rarely mutated cancer genes; all of the genes in the subnetwork are mutated in fewer than 35 samples (1.1%) yet four of five genes have recently been proposed as novel cancer genes.

Many of the subnetworks were found to exhibit significant enrichment for mutations in a subset of cancer types, including many previously unreported associations. Certain genes were also found within these subnetworks that were enriched for mutations in particular cancer types. In addition, the heat diffusion based genetic network analysis disclosed herein provides a clearer and more robust summary of subnetworks and novel genes than network analysis of individual cancer types. These subnetworks and linkers include a total of 147 genes, including many well-known cancer genes and pathways, but also including genes with mutations that are too rare to be significant by the single-gene tests. In total, 92 genes in the network analysis subnetworks are not reported by any of five single-gene tests (MutSigCV, Oncodrive-FM and -CIS, MuSiC, or GISTIC2). Many of these genes have literature evidence supporting a potential role in cancer, while others are in biological processes that suggest these genes warrant further study.

### Co-Occurrence and Mutual Exclusivity of Mutations in Subnetworks

Cancer cells are thought to harbor multiple driver mutations that perturb multiple biological functions. Consequently, co-occurrence of mutations across distinct pathways should be observed. Consistent with this model, it was found according to aspects of the disclosure that four pairs of subnetworks exhibit significant (P<0.05) co-occurring mutations across the Pan-Cancer cohort: TP53 and NOTCH signaling, TP53 and ERRB signaling, PI3K signaling and cohesion complex, and PI3K and ASCOM complex. Multiple pairs of genes within these subnetworks were show co-occurring mutations and several other pairs of subnetworks were shown to exhibit significant (P<0.01) co-occurring mutations in individual cancer types. While there is modest enrichment for co-occurrence in a few cancer types, the results are not statistically significant. This co-occurrence provides further support that the heat diffusion based genetic network analysis subnetworks represent distinct biological functions that are mutated in samples; such co-occurrence is not programmed into the algorithm.

### Expression and Germline Filtering

Most of the subnetworks identified by the heat diffusion based genetic network analysis were also found when the requirement for RNA-seq expression was removed, demonstrating the robustness and scalability of the network analysis. Notable among additional subnetworks identified when the RNA-seq expression requirement was removed, is a subnetwork containing members of the telomerase complex (including (TERT and TEP1) that has a well-studied role in cancer. Heat diffusion based genetic network analysis was also performed using a more aggressive criterion to remove potential germline (syn1729383). Only minor differences were found in the subnetworks, demonstrating that the reported subnetworks are altered by somatic aberrations in these samples.

### Statistical Significance

The statistical significance of the subnetworks and network analysis consensus was evaluated using a two-stage statistical test more fully described in Algorithms for Detecting Significantly Mutated Pathways in Cancer, Vandin et al., J. Comput. Biol. (2011). The first stage is to compute a P-value for the statistic Xₖ, the number of subnetworks of size ≦k reported by the network analysis. The empirical distribution of Xₖ is computed by running the algorithm on random data where the heat scores on genes is permuted, restricting the permutation to the genes that are in the network and not removed by the expression filter.

The second stage computes the FDR for the set of significant subnetworks, as described in Algorithms for Detecting Significantly Mutated Pathways in Cancer, Vandin et al., J. Comput. Biol. (2011). According to one example the equation

$${γ}_{i} = \frac{1}{{2}^{i - 1}}$$

may be used for a set of subnetworks of size i, for i=2, . . . , 8, and

$${γ}_{9} = 1 - {\sum }_{i = 2}^{8} \frac{1}{{2}^{i - 1}} ,$$

since only subnetworks of size between 2 and 9 are considered.

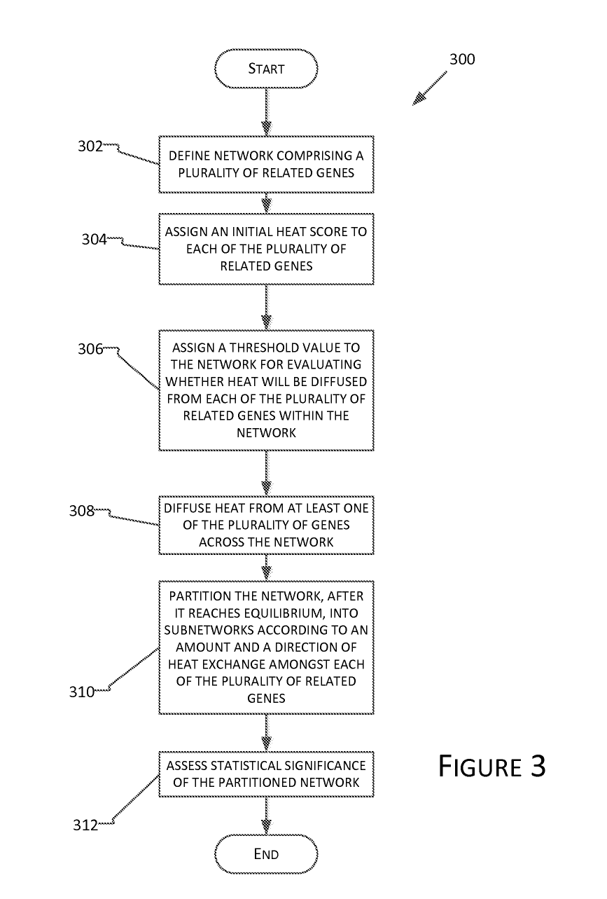

In view of the exemplary systems described herein, methodologies that may be implemented in accordance with the disclosed subject matter will be better appreciated with reference to the flowchart of FIG. 3. For purposes of simplicity of explanation, the methodologies are shown and described as a series of operations. However, it is understood that the method described with reference to FIG. 3 is not limited to the order of the operations described and that operations may be performed in varying order or concurrently with other operations. Moreover, not all illustrated operations may be required to implement the methods described.

Referring to FIG. 3, the method 300 begins with a classification operation 302 in which a network comprising a plurality of related genes is defined. The network may comprise a genome-scale interaction model that represents a network of different genes and the interactions between the different genes. Various genome-scale interaction models may be obtained from third parties and any appropriate model may be used depending on the nature of the data to be analyzed. Conceptually, a genome-scale interaction model may be thought of as a network of nodes with edges connecting the nodes, where each node represents a gene and an edge between two nodes represents an interaction between two genes. In examples, defining the network may comprise receiving an identifier that identifies a particular of the network. In such examples, the network may then be retrieved using the identifier.

Flow continues to a heat score operation 304 in which an initial heat score is assigned to each of the plurality of related genes. The initial heat score may be assigned by utilizing a model such as MutSigCV correlating to mutation significance for each individual gene in the plurality of related genes. Alternatively, or in addition to mutation significance, the initial heat score may be correlated with analyzing the mutation frequency of each of the plurality of related genes. Where the initial heat score is assigned by utilizing a MutSigCV model, the score may be assigned to genes having a MutSigCV q-score in the range of 0 to 0.99. In additional examples the initial heat score may be assigned to genes having a MutSigCV q-score in the range of 0.1 to 0.99.

According to some aspects, the mutation frequency of the plurality of related genes may comprise determining a proportion of samples with at least one nucleotide variant, at least one CNA, at least one indel, and/or at least one splice-site mutation.

Flow continues to threshold operation 306 in which a threshold value is assigned to the network for evaluating whether heat will be diffused from each of the plurality of related genes within the network. The assignment of a threshold value may additionally comprise filtering a subset of the plurality of related genes from the network by, for example, removing ultra and hypermutators. This assignment might also comprise removing genes from the network which contain less than a pre-defined percentage of SNVs. In examples, such a percentage may be in the range of 0.01-10%. In another example, such a percentage may be in the range of 1-7%, and in an additional example such a percentage may be in the range of 3-5%.

In another example, genes may be removed from analysis if they have more than a pre-defined percentage of SNVs but were not defined as significant according to single gene tests of significance such as MutSigCV. According to some aspects, such a percentage may be in the range of 1-5%. In other aspects such a percentage may be in the range of 2-4%, and in yet another example such a percentage may be in the range of 2.5-3%.

Flow continues to diffusion operation 308 in which heat is diffused from at least one of the plurality of genes across the network. According to examples, the heat diffusion based genetic network analysis assigns heat to each gene (node) in an interaction network according to a gene score encoding the frequency and/or predicted functional impact of mutations in the gene. This heat spreads to neighboring nodes using an insulated heat diffusion process.

Flow proceeds to a subnetwork partitioning operation 310, where, after the network reaches equilibrium, it is partitioned into subnetworks based in part on an amount and a direction of heat exchange among each of the plurality of related genes. Thus, the partition depends on both the individual gene scores and the local topology of protein interactions.

From operation 310 the flow continues to a statistical significance operation 312 in which statistical significance of the each subnetwork is assessed. In some examples, assessing statistical significance of the extracted data comprises computing a gene score, which is defined by a p-value and a FDR for each of: SNVs, small indels, splice-site mutations from exome sequencing data, CNAs from SNP array data, and gene expression from RNA-seq data.

FIG. 4 illustrates an example of mutation scores and heat assignments. In one example, heat scores are assigned to each gene (node) using the heat diffusion based genetic network analysis in an interaction network according to gene score encoding frequency or the predicted functional impact of mutations in the gene, depicted here as SNVs and small indels 402, and CNAs 404. At 406, heat assignment to the various genes is shown according to a heat scale 408. After heat is assigned to each gene, heat distribution is determined, which is further described with reference to FIG. 5.

As illustrated in FIG. 5, heat is distributed among the network 501. The heat is spread to neighboring nodes using an insulated heat diffusion process as further illustrated by 503 showing heat from node v diffusing to node u.

At the equilibrium heat distribution, the network is partitioned into subnetworks, as illustrated and described with reference to FIG. 6.

At FIG. 6, the network is partitioned into significantly hot subnetworks 602, 604, and 606 based on the amount and direction of heat exchange between pairs of nodes. Thus, the partition depends on both the individual gene scores and the local topology of protein interactions. The statistical significance (p-value and FDR) for the resulting subnetworks is computed using the same procedure on random data. According to aspects of the disclosure, gene scores are computed according to SNVs, small indels, and splice-site mutations (from exome sequencing data), CNAs (from SNP array data) and gene expression (from RNA-seq data).

FIG. 7 illustrates network analysis similarity between neighboring genes/nodes in a small graph. Node u has degree one, therefore it sends most of its heat to its one neighbor v. Node v has multiple neighbors, and therefore sends less of its heat to each of its neighbors.

According to some aspects, the one or more identified subnetworks may be provided to a doctor, researcher, etc. to aid in cancer or other disease-based research. As such, the examples disclosed herein provide analytical tools that may be used by pharmaceutical companies, biotech companies, diagnostic companies, and/or universities for research and/or may be utilized in the diagnosis or treatment of cancer. For example, there are currently drugs that target specific somatic mutations in cancer, and more of such drugs are being developed. However, not all patients have a mutation in one of these “actionable” mutations. By identifying additional genes with mutations in the same subnetwork, one might be able to identify new drug targets and/or identify patients who would respond to existing treatments because they have other mutations in the same subnetworks.

1. A computer-implemented method comprising:
defining a network comprising a plurality of related genes;
assigning an initial heat score to each of the plurality of related genes;
assigning a threshold value to the network for evaluating whether heat will be diffused from each of the plurality of related genes within the network;
diffusing heat from at least one of the plurality of genes across the network;
based on an equilibrium state, partitioning the network into subnetworks based on an amount and a direction of heat exchange among each of the plurality of related genes; and
assessing statistical significance of the partitioned network.

2. The method according to claim 1, further comprising:
computing a hierarchy of partitions into subnetworks; and
assessing statistical significance of the hierarchy of partitions.

3. The method according to claim 1, wherein assigning an initial heat score to each of the plurality of related genes utilizes a statistical model for assigning a heat score correlating to mutation significance for each of the plurality of related genes.

4. The method according to claim 1, wherein assigning an initial heat score to each of the plurality of related genes further comprises analyzing a mutation frequency of each of the plurality of related genes and assigning a correlating heat score to each of the plurality of related genes based on its mutation frequency.

5. The method according to claim 4, wherein analyzing the mutation frequency of each of the plurality of related genes further comprises determining a proportion of samples with at least one single nucleotide variant.

6. The method according to claim 4, wherein analyzing the mutation frequency of each of the plurality of related genes further comprises determining a proportion of samples with at least one copy number aberration.

7. The method according to claim 4, wherein analyzing the mutation frequency of each of the plurality of related genes further comprises determining a proportion of samples containing at least one indel.

8. The method according to claim 4, wherein analyzing mutation frequency of each of the plurality of related genes further comprises determining a proportion of samples containing at least one splice-site mutation.

9. The method according to claim 1, wherein assigning an initial heat score to each of the plurality of related genes comprises analyzing a frequency with which each of the plurality of related genes is mutated, and assigning a mutation significance to each of the plurality of related genes utilizing a statistical model for determining mutation significance as defined by q-values.

10. The method according to claim 1, wherein assigning a threshold value to the network further comprises filtering a subset of the plurality of related genes from the network.

11. The method according to claim 10, further comprising removing ultra and hypermutators.

12. The method according to claim 10, further comprising removing one or more genes from the network that have less than a pre-defined percentage of single nucleotide variants.

13. The method according to claim 12, wherein the pre-defined percentage of single nucleotide variants is a percentage in the range of 1-5%.

14. The method according to claim 1, wherein assessing statistical significance of the extracted data comprises computing a gene score wherein the gene score is defined by p-value and False Discovery Rate (FDR) for each of: single nucleotide variants, small indels, splice-site mutations from exome sequencing data, copy number aberrations from SNP array data, and gene expression from RNA-seq data.

15. The method according to claim 1, further comprising assigning a plurality of heat scores to each of the plurality of related genes, wherein the plurality of heat scores are combined prior to diffusing heat from at least one of the plurality of genes across the network.

16. The method according to claim 1, further comprising assigning a plurality of heat scores to each of the plurality of related genes, wherein the plurality of heat scores are applied to each of the plurality of related genes individually, and each individual heat score for each individual gene is diffused across the network.

17. The method according to claim 16, wherein assessing statistical significance of the portioned network comprises combining data from the plurality of heat scores after diffusing heat from at least one of the plurality of genes across the network.

18. A system comprising:
at least one processor; and
a memory operatively connected with the at least one processor, the memory comprising computer executable instructions that, when executed by the at least one processor, perform a method comprising:
defining a network comprising a plurality of related genes;
assigning an initial heat score to each of the plurality of related genes;
assigning a threshold value to the network for evaluating whether heat will be diffused from each of the plurality of related genes within the network;
diffusing heat from at least one of the plurality of genes across the network;
partitioning the network, after it reaches equilibrium, into subnetworks according to an amount and a direction of heat exchange amongst each of the plurality of related genes; and
assessing statistical significance of the partitioned network.

19. The system according to claim 18, further comprising:
arranging the subnetworks near a plurality of cancer types where the subnetworks are enriched for mutations; and
utilizing a force-directed layout to associate the subnetworks with the plurality of cancer types.

20. The system according to claim 18, further comprising:
assigning a plurality of heat scores to each of the plurality of related genes, wherein the plurality of heat scores are combined prior to diffusing heat from at least one of the plurality of genes across the network.

21. (canceled)
